(19) United States
(12) Patent Application Publication
(10) Pub. No.: US 2009/0088091 A1
(43) Pub. Date: Apr. 2, 2009

(54) Transmitter for Multiple Standards

(75) Inventors: David H. Shen, San Jose, CA (US); Chien-Meen Hwang, San Jose, CA (US); Ann P. Shen, Saratoga, CA (US)

Correspondence Address: FISH & RICHARDSON P.C., P.O. BOX 1022, MINNEAPOLIS, MN, 55440-1022, US

(73) Assignee: NANOAMP SOLUTIONS INC. (CAYMAN), Santa Clara, CA (US)

(21) Appl. No.: 12/240,498

(22) Filed: Sep. 29, 2008

Related U.S. Application Data
(60) Provisional application No. 60/975,782, filed on Sep. 27, 2007.

(51) Int. Cl. H04B 1/02

(52) U.S. Cl. 455/102

(57) ABSTRACT

Generally, implementations provide a circuit framework that uses phase and amplitude modulation with several voltage-controlled-oscillators (VCOs) and corresponding variable gain amplifiers (VGAs) to generate and amplitude and phase modulated signals that are summed to an output signal for a transmitter circuit. The implementations can involve decomposing an input signal into a number of decomposed signals using a signal decomposer component, in which each of decomposed signals includes phase and amplitude information. The signal decomposer component can interact with each of the VCOs and corresponding VGAs to conduct the phase and amplitude modulation for the amplitude and phase modulated signals. The multiple standard transmitter circuit can be used for one or more communication standards, such as Global System for Mobile Communications (GSM), a Wideband Code Division Multiple Access (WCDMA), or High-Speed Uplink Packet Access (HSUPA), among others.

### CROSS REFERENCE TO RELATED APPLICATIONS

This application claims the benefit of priority to U.S. Provisional Application No. 60/975,782, entitled “A TRANSMITTER FOR MULTIPLE STANDARDS,” filed on Sep. 27, 2007, the disclosure of which is incorporated by reference.

### TECHNICAL FIELD

This disclosure relates to transceivers and transmitters, such as transceivers for one or more wireless standards.

### BACKGROUND

Transmitters are commonly used in electronic communications to transmit signals for various communication, information processing, medical, or entertainment applications. The signals may be transmitted via an antenna and may have various power levels for particular applications. In electronic integrated circuits, the transmitter may be part of a transceiver design, such as in a superheterodyne, a direct launch, a polar modulated, or an offset loop-type transmitter.

### SUMMARY

Generally, some implementations feature a transmitter circuit. The transmitter includes a signal decomposer component configured to decompose an input signal into a number of decomposed signals. Each of the decomposed signals includes phase and amplitude information. The transmitter includes a number of phase-lock-loops (PLL) configured to receive the decomposed signals, and generate a number of phase-modulated signals by performing modulation based on the phase information from the decomposed signals. The transmitter includes a number of variable amplifiers (VGAs) configured to amplify the phase-modulated signals with the amplitude information from the decomposed signals and to a number of generated amplitude and phase modulated signals. The transmitter includes a summer configured to sum the amplitude and phase modulated signals to generate a modulated output signal.

These and other implementations can optionally include one or more of the following features. Each of the PLLs can be configured to receive a reference signal. A first input terminal of each of the VGAs can be coupled to an output terminal of one of the PLLs. A number of the PLLs can be equal to a number of the VGAs. A number of PLLs can be equal to a number of decomposed signals. The signal decomposer component can be configured to receive the input signal at an input terminal of the signal decomposer component. The signal decomposer component can include a number of output terminals, in which a first input terminal of each of the PLLs can be coupled to one of the output terminals of the signal decomposer component, and a second input terminal of each of the VGAs can be coupled to one of the output terminals of the signal decomposer component. Each of the PLLs can include a voltage controlled oscillator (VCO) that couples to the first input terminal of one of the VGAs. Each of the PLLs can be configured to receive the reference signal and the phase information of one of the decomposed signals, and generate one of the phase-modulated signals by modulating with the phase information from the one decomposed signals. Each of the VGAs can be configured to amplitude modulate or amplify one of the phase-modulated signals with the amplitude information from one of the decomposed signals and generate one of the amplitude and phase modulated signals. Each of the PLLs can include a modulator component that couples to the first input terminal of each of the PLLs, in which the reference signal can be received at a second input terminal of each of the PLLs. The signal decomposer component can be configured to interact with each of the PLLs and the VGAs to conduct phase and amplitude modulation for the amplitude and phase modulated signals. The amplitude and phase modulated signals may include frequencies that are higher than frequencies for the decomposed signals. The amplitude and phase modulated signals can include one or more carrier frequencies. The decomposed signals can include a set of K decomposed signals, in which K can represent a number that is equal to two or greater than two. Any of the terminals of the transmitter can be single-ended or differential. The PLLs can include a set of K PLLs, and the VGAs can include a set of K VGAs. The transmitter can be configured to perform a modulation scheme that includes any combination of an amplitude modulation scheme, a frequency modulation scheme, or a phase modulation scheme. K can be an integer number and can be equal to or less than a symbol number of one of the modulation schemes. The input signal can be a digital input signal, the symbol number can be equal to M=2^{N}, and N can be a number of bits for the digital input signal. The modulation scheme can include any of a phase shift keying (PSK) scheme, including subtypes such as a quadrature PSK (QPSK), a quadrature amplitude modulation (QAM) scheme, including subtypes such as an 8-, 16- and 64-point QAM (8QAM, 16QAM and 64QAM), a minimum shift keying (MSK) including subtypes, such as a Gaussian MSK (GMSK), a frequency shift keying (FSK) scheme, an amplitude shift keying (ASK) scheme, or an orthogonal frequency division multiplexing (OFDM) scheme. The transmitter can be configured for more than one of the modulation schemes. The transmitter can be configured for a system that includes any of a Global System for Mobile Communications (GSM), a Wideband Code Division Multiple Access (WCDMA) system, or a High-Speed Uplink Packet Access (HSUPA) system. The input signal can be an analog signal. A number of the PLLs in the transmitter or a number of the VGAs in the transmitter can be a function of 2π/J, where J can represent a positive integer that is less than the symbol number. The input analog signal can be a product of pulse shaping a digital input signal. The summer can be configured to sum the phase-modulated signals to produce a summed phase-modulated signal and the VGAs can include one VGA configured to amplify the summed phase-modulated signal with the amplitude information derived from the input signal to produce another modulated output signal. Any of the PLLs can include at least any one of a current controlled-oscillator, a ring oscillator, a relaxation oscillator, a Colpitts oscillator, a Hartley oscillator, a two-integrator oscillator, an LC oscillator, or an RC oscillator. Any of the PLLs can include any one of a first type of PLL having active and passive loop filters, a second type of PLL having charge pump-based or voltage mode-based integrators, a third type of PLL having a type of direct voltage controlled oscillator (VCO) modulation, a fourth type of PLL having an analog PLL, a fifth type of PLL comprising a digital PLL, a sixth type of PLL having a combined analog and digital PLL, a seventh type of PLL having an integer-based PLL, a fractional-based PLL, or a combined integer and fractional-based PLL, an eight type of PLL having a single-loop or multi-loop PLL, a ninth type of PLL having an oscillator, a crystal oscillator, a dielectric resonator, or an acoustic wave resonator, or a tenth type of PLL having any combination of the types of PLL.

In general, some implementations feature a method for a transmitter. The method includes producing two or more phase-modulated signals from two or more voltage controlled oscillators (VCOs), in which each of the VCOs produces one of the phase-modulated signals. The method involves producing two or more phase and amplitude modulated signals by amplifying the two or more phase-modulated signals with two or more variable gain amplifiers (VGAs), in which each VGA amplifies one of the phase-modulated signals. The method includes summing the two or more phase and amplitude modulated signals with a summer circuit to produce an output signal. The transmitter includes the summer circuit, the two or more VGAs, and two or more phase-locked loops (PLLs). Each of the PLLs includes at least one of the VCOs.

These and other implementations can optionally include one or more of the following features. The summer circuit can be configured to sum the two or more phase-modulated signals to produce a summed phase-modulated signal, and the two or more VGAs can include one VGA configured to amplify the summed phase-modulated signal with an amplitude information associated with the input signal to either replace the output signal or produce another output signal. The method can include performing amplitude modulation with the VGAs. The transmitter can include a signal decomposer component. Each of the PLLs can be configured to receive a reference signal and one of the decomposed signals, and each of the PLLs also can be configured to generate one of the phase-modulated signals by performing modulation with the phase information from the one decomposed signals. Each of the VGAs can be configured to amplify one of the phase-modulated signals with the amplitude information from one of the decomposed signals and generate one of the amplitude and phase modulated signals. The method can include: receiving an input signal at the signal decomposer component; decomposing the input signal with the signal decomposer component to generate decomposed phase and amplitude information from the input signal; receiving the reference signal in each of the two or more PLLs; sending the decomposed phase information from the signal decomposer component to each of the two or more PLLs to perform phase modulation using the reference signal of each of the two or more PLLs; and sending the decomposed amplitude information from the decomposed input signal to each of the two or more VGAs to perform amplitude modulation when amplifying the two or more phase-modulated signals with the two or more VGAs. The method can include using the signal decomposer component to control the performing of the phase modulation and the amplitude modulation. The phase modulation can include performing a frequency up-conversion process involving at least one carrier frequency. The input signal may be an analog signal, and the method can involve generating the analog signal by pulse shaping a digital input signal. The two or more phase-modulated signals can include at least two different carrier frequencies. Any of the carrier frequencies can be higher than frequencies from signals generated from the signal decomposer component. The method can include modulating the input signal using a modulation scheme that involves any of the following: a phase shift keying (PSK) scheme, a quadrature amplitude modulation (QAM) scheme, a frequency shift keying (FSK) scheme, an amplitude shift keying (ASK) scheme, an orthogonal frequency division multiplexing (OFDM) scheme, a multiple-input and multiple-output (MIMO) scheme, a Gaussian minimum-shift keying (GMSK) scheme, or a multiple-channel modulation scheme. The method can include using one or more decomposing algorithms for decomposing the input signal with the signal decomposer component. The input signal can be a digital signal. The input signal can include N number of bits to represent a state of the input signal, in which the input signal can be associated with a symbol number M, and the symbol number M can be a function of 2^{N}. A number of the PLLs in the transmitter or a number of the VGAs in the transmitter can be equal to or less than the symbol number. A number of the PLLs in the transmitter or a number of the VGAs in the transmitter can be a function of 2π/J, where J can represent a positive integer that is less than the symbol number. The input signal can include an analog signal. The analog signal can include a digitally-sampled analog signal. The input signal can be received from a baseband signal component. A digital input signal can be filtered with a pulse shaping functions to the amplitude and phase of the input signal with values between the symbol points to form an analog signal, in which the filtering can help shape a bandwidth of a transmitted signal spectrum. Each of the VGAs can be coupled with at least one of the PLLs, and each of the VGAs can be coupled to a different PLL. The method can involve representing the output signal in a type of constellation diagram, in which the type of constellation diagram can correspond with a type of modulation scheme performed with the production of the output signal. The type of modulation scheme can include a digital modulation or a continuous minimum shift modulation. The method can include using the transmitter in a system for a Global System for Mobile Communications (GSM), a Wideband Code Division Multiple Access (WCDMA) system, or a High-Speed Uplink Packet Access (HSUPA) system. The method can include using the transmitter in a system for Worldwide Interoperability for Microwave Access (WiMAX), multi-band radios, global-positioning systems (GPS), RX Diversity, wireless local area network (WiLAN), or frequency modulation (FM) or satellite receivers.

In general, some implementations include features for a method of operating a transmitter circuit. The method includes decomposing an input signal into a number of decomposed signals using a signal decomposer component, in which each of the decomposed signals includes phase and amplitude information. The method also involves the following: receiving the decomposed signals with a number of phase lock loops (PLLs); generating a number of phase-modulated signals with the PLLs by performing modulation based on the phase information from the decomposed signals; amplifying the phase-modulated signals with a number of variable amplifiers (VGAs) using the amplitude information from the decomposed signals; generating amplitude and phase modulated signals from the VGAs; and summing the amplitude modulated signals with a summer to generate a modulated output signal. The signal decomposer component is coupled to each of the PLLs and each of the VGAs. Each of the VGAs is coupled to one of the PLLs, and each of the VGAs is coupled to the summer.

These and other implementations can optionally include one or more of the following features. The method can include using the signal decomposer component to interact with each of the PLLs and the VGAs to conduct phase and amplitude modulation for each of the amplitude and phase modulated signals. The method can include modulating the input signal using a modulation scheme that can include any of the following: a phase shift keying (PSK) scheme, a quadrature amplitude modulation (QAM) scheme, a frequency shift keying (FSK) scheme, an amplitude shift keying (ASK) scheme, an orthogonal frequency division multiplexing (OFDM) scheme, a multiple-input and multiple-output (MIMO) scheme, a Gaussian minimum-shift keying (GMSK) scheme, or a multiple-channel modulation scheme. The method can involve summing the phase-modulated signals using the summer to produce a summed phase-modulated signal, and the VGAs can include one VGA that may be configured to amplify the summed phase-modulated signal with an amplitude information of the input signal to generate another modulated output signal or to replace the modulated signal. The method can involve receiving a reference signal into the PLLs. The reference signal can be received from a voltage reference source. The method can involve sending the modulated output signal to a power amplifier for transmission. Each of the PLLs can be configured to receive a reference signal and one of the decomposed signals, and each of the PLLs can be configured to generate one of the phase-modulated signals by performing modulation with the phase information from the one decomposed signals. Each of the VGAs can be configured to amplify one of the phase-modulated signals with the amplitude information from one of the decomposed signals, and each of the VGAs can be configured to generate one of the amplitude and phase modulated signals. The decomposed signals can include a set of K decomposed signals, in which K can represent a number equal to two or greater than two. The PLLs can include a set of K PLLs, and the VGAs can include a set of K VGAs. The transmitter can be configured to perform a modulation scheme that can involve any combination of an amplitude modulation scheme, a frequency modulation scheme, or a phase modulation scheme. K can represent integer number. K can be equal to or less than a symbol number of one of the modulation schemes. The input signal can be a digital input signal. The symbol number can be equal to M=2^{N}, in which N can represent a number of bits for the digital input signal. A number of the PLLs in the transmitter or a number of the VGAs in the transmitter can be a function of 2π/J, in which J can represent a positive integer number that is less than the symbol number. The modulated output signal can include one or more carrier frequencies. The input signal can include an analog input signal. The method can include generating the analog signal by pulse shaping a digital input signal. The analog signal can include a digitally-sampled analog signal. The input signal can be received from a baseband signal component. The method can include assigning a numerical weight to each of the amplitude and phase modulated signals from the VGAs before summing the amplitude and phase modulated signals. The modulated output signal can include a weighted sum of the amplitude and phase modulated signals. The method can include performing signal processing with the signal decomposer component.

Generally, one or more implementations can involve summing multiple phase modulated sinusoidal signals to generate a summed modulated sinusoidal signal, which can be, for example, a phase, frequency, and/or amplitude modulated transmitter output signal. Some implementations may use phase modulation on several voltage-controlled-oscillators (VCOs), with the outputs of the VCOs summed to generate phase and amplitude-modulated transmitter output signals. The described techniques can be compatible with digital algorithms used in communication systems.

In general, in some aspects, an input signal can be decomposed into a series of signals using a decomposition algorithm depending on characteristics of the input signal, and/or requirements of one or more system designs. In some implementations, a modulated input signal of a modulation scheme can use a decomposition algorithm involving symbol points in a constellation diagram for a particular digital modulation scheme.

In other implementations, a decomposition algorithm can divide a constellation diagram into different phase sections to limit a PLL's phase changes within a designated phase section. When an input signal is an analog signal, the trajectory of the input signal may have a requirement for many points in a constellation diagram or even a solid plane. Thus, decomposing the input signal using a type of phase section algorithm can be particularly useful.

Further, in some implementations, a modulated input signal can include two or more modulation schemes and the decomposition algorithm may decompose an input signal in response to the two or more modulation schemes.

The details of one or more implementations are set forth in the accompanying drawings and the description below. Other features will be apparent from the description and drawings, and from the claims.

### DESCRIPTION OF THE DRAWINGS

FIG. 1 is a schematic of an example of a multi-band superheterodyne transmitter.

FIG. 2 is a schematic of an example of a phase locked loop (PLL).

FIG. 3 is a schematic of an example of a multi-standard transmitter.

FIG. 4 is a diagram of an example of a technique to decompose an input signal for transmission by a transmitter.

FIG. 5 is a diagram of an example of a transmitting technique involving decomposing an input signal for quadrature phase-shift-keying (QPSK) modulation scheme.

FIG. 6 is an example of a technique for the transmitter to use an alternative decomposition algorithm.

FIG. 7 is an example of constellation diagrams of an 8-Quadrature amplitude modulation QAM.

### DETAILED DESCRIPTION

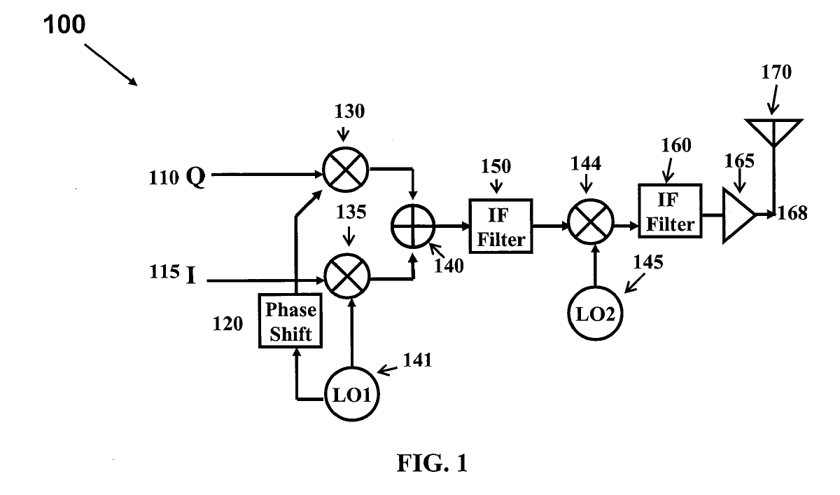

One or more implementations provide for a transmitter and/or transceiver architecture that sums multiple, phase and/or amplitude modulated sinusoidal signals and generate phase, frequency, and/or amplitude-modulated transmitter output signals. Generally, any modulation type can be decomposed into a series of phase and amplitude modulated sinusoidal waveforms that can be summed together to produce the final waveform. In some implementations, phase modulation is performed on several VCOs, and each output signal of the VCOs can be amplitude modulated by a VGA before being summed together to form the phase and amplitude modulated sinusoidal signal to be transmitted. The VCOs can be part of a phase-locked loop (PLL) that is used to control the phase modulation. The disclosed transmitters can be used in place of a superheterodyne architecture (e.g., in FIG. 1), as well as other types of transmitters, such as the offset loop-type transmitters, direct launch transmitters, or polar modulated transmitters, among others.

In some implementations, techniques can be employed to add two or more phase-only modulated sinusoid signals from several VCOs to produce a phase modulated signal before being amplified by a VGA to generate a modulated output signal (e.g., both phase and amplitude modulated) sinusoidal signal output. The modulated sinusoidal signal output is capable of being used with multiple wireless standards (e.g., 2G, 3G, 4G-type, WiMax standards) for multi-standard transmitter operation.

As shown in one or more implementations, a modulated sinusoidal output can be generated by the additive combination of other phase and amplitude modulated sinusoids. In some implementations, multiple VCOs and VGAs can generate arbitrary transmit waveforms. Some implementations may be implemented on an integrated chip, and may be able to enhance a transmitter performance, lessen a requirement for external components and/or help to minimize design costs. Some of the implementations may avoid VCO pulling problems, poor noise performance, and/or handle high bandwidth modulation. Some of the implementations may have low noise and high linearity, while having the functionality for phase and amplitude modulation.

FIG. 1 is a schematic of an example of a superheterodyne transmitter 100. Transmitter 100 has a mixer 130 coupled to a first input terminal 110 for a baseband quadrature signal (Q signal), and a mixer 135 coupled to a second input terminal 115 for a baseband in-phase signal (I signal). A first local oscillator 141 provides a local oscillator signal to the mixer 135 and to a 90-degree phase shifter 120. An output of the phase shifter 120 is coupled to the mixer 130. The output mixers 130, 135 are coupled to a summer 140. The output of the summer is coupled to an input of an intermediate frequency (IF) filter 150. An output of the intermediate frequency filter 150 is coupled to a mixer 144, which also receives a second local oscillator signal from a second local oscillator 145. An input of radio frequency (RF) filter 160 is coupled to the mixer 144. The output of the RF filter 160 is coupled to the input of a power amplifier 165. The output of the power amplifier 165 is coupled to an antenna 170 at an output terminal 168 of the transmitter 100.

During operation, the baseband in-phase signal I and baseband quadrature signal Q are modulated at an IF and combined by mixers 130 and 135 and the summer 140. A first local oscillator signal (LO1) from the first local oscillator 141 drives mixer 135 and the 90-degree phase shifter 120 whose output drives mixer 130. The intermediate frequency (IF) filter 150 removes unwanted harmonic images from the oscillator signal. The mixer 144 is driven by a second local oscillator signal (LO2) from the second local oscillator 145 and mixes the intermediate frequency signal to a radio frequency (RF) signal. The RF filter 160 removes an unwanted image frequency and any harmonics of the mixing process. The subsequent power amplifier 165 drives the antenna 170 at the output terminal 168 of the transmitter with the power amplified transmitter RF signal.

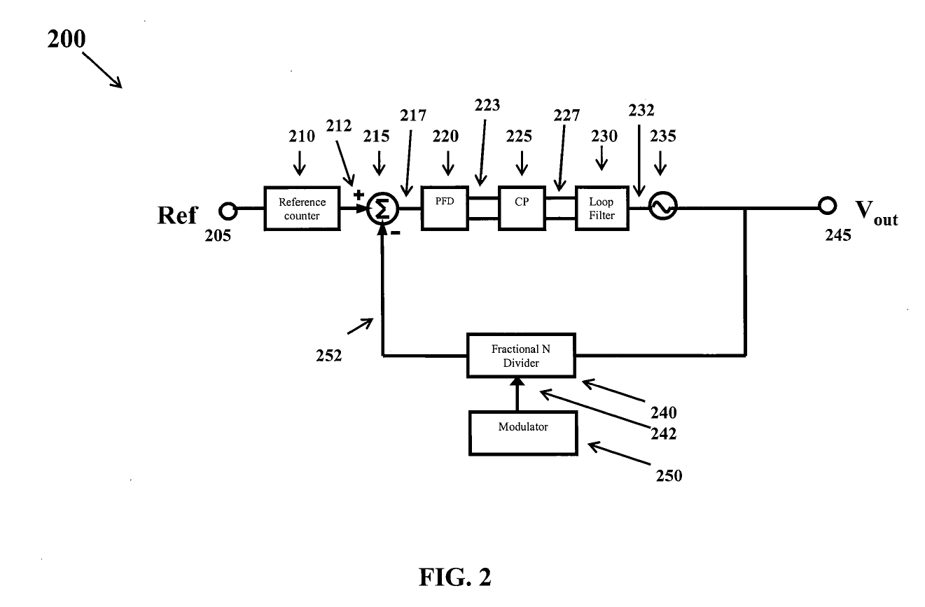

FIG. 2 is a schematic of an example of a phased-locked loop (PLL) 200 that has a VCO 235 at the output terminal 245. The PLL 200 has a reference counter 210 at an input terminal 205 of the PLL. A reference counter output terminal 212 is coupled to a summer 215, and a fractional N divider output terminal 252 from a fractional N divider 240 is coupled to the summer 215. A summer output terminal 217 is coupled to a phase/frequency detector (PFD) 220, and a phase/frequency detector output terminal 223 is coupled to a charge pump (CP) 225. An output terminal 227 of the charge pump 225 is coupled into a loop filter 230, and the output terminal 232 of the loop filter 230 is coupled into the VCO 235. An output terminal 245 of the PLL 200 is the output terminal of the VCO 235. The output terminal 245 is coupled back into the fractional N divider 240. An output terminal 242 of a modulator 250 is also coupled to the fractional N divider 240.

In general, the VCO 235 can produce numerous edges that can be used to increase a number of phase comparisons for the PLL 200. In particular, FIG. 2 shows that a reference signal Ref enters the input terminal 205 at the reference counter 210. The summer 215 subtracts the output signal of a fractional N divider 240 from of the reference counter 210. The fractional N divider 240 is modulated by the modulator 250 to control the phase of the PLL output signal. The output signal of the summer 215 is sent to the PFD 220 and then the charge pump CP 225. The output signal of the CP 225 is sent to a loop filter 230, followed by the VCO 235. The VCO output signal value Vₒᵤₜ is coupled back into the fractional N divider 240. Vout 245 is also the output signal value of the PLL 200. The modulator 250 may be considered part of the PLL in some implementations, and the modulator 200 may not be considered part of the PLL in other implementations.

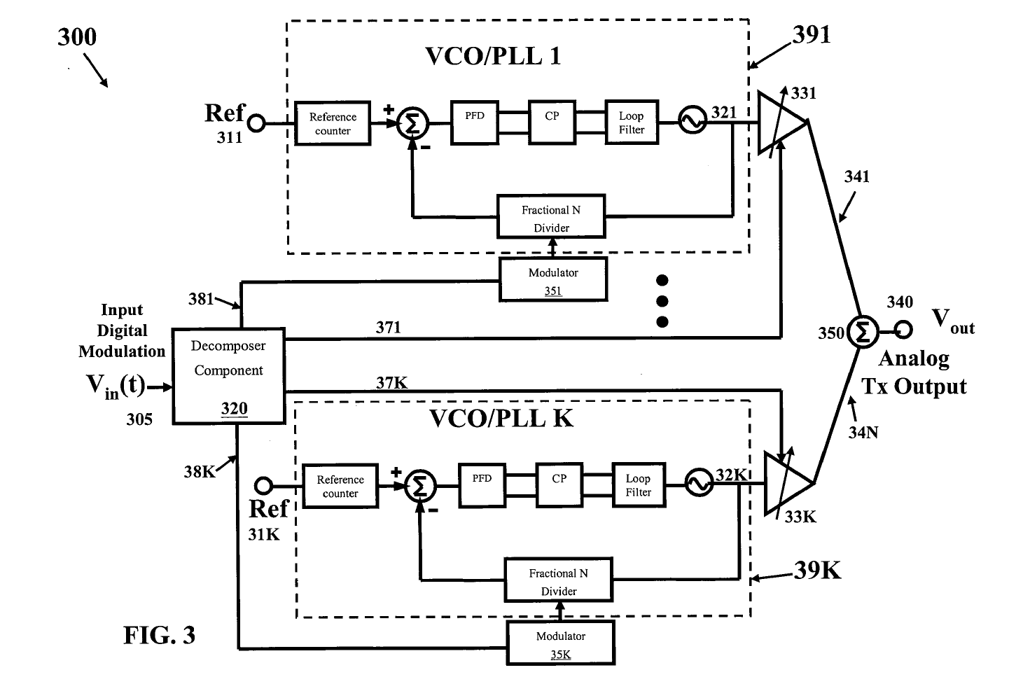

FIG. 3 shows an example of a transmitter 300. The transmitter 300 can include a signal decomposer component 320 that receives an input signal Vᵢₙ(t) at an input terminal 305, in which the signal decomposer component 320 can include features for a signal decomposition of an input signal. The transmitter 300 can include K numbers of PLLs 391-39K (where K is a positive integer number of two or greater) and K numbers of VCOs 321-32K that can be used to up-convert an input signal Vᵢₙ(t) (e.g., to phase modulate a carrier signal by the phase of the input signal Vᵢₙ(t)) using K decomposed signals from the input signal Vᵢₙ(t), where t is time. The transmitter 300 can include K numbers of variable gain amplifiers (VGAs) 331-33K at the output of the PLLs 391-39K to take the phase-only modulated input signals and amplify them (e.g., amplitude modulation).

Transmitter 300 can include multiple PLLs 391-39K that are numbered from 1 to K. Each PLL (e.g., PLLs 391-39K) can receive a reference signal Ref at each of the PLL input terminals 311-31K. The PLLs 391-39K can have output terminals 321-32K that can be connected to the VGAs 331-33K. For example, the output terminal 321 of PLL1 391 can be coupled the input of VGA 331, and the output terminal 32K of PLLK 39K can be coupled to the input terminal of VGA 33K. An output terminal 341 of VGA 331 is coupled to a summer 350, and an output terminal 34K of VGA 33K is coupled to the summer 350 as well. The output terminal 340 of the summer 350 can be the output terminal 340 of the transmitter 300.

The transmitter 300 can also include a signal decomposer component 320 of the input signal, which can receive a modulated (e.g., using a modulation scheme such as a phase-shift-keying modulation (PSK)) input signal Vᵢₙ(t) from a baseband component (not shown) at the input terminal 305 of the signal decomposer component 320. The modulated input signal Vᵢₙ(t) can be an analog signal (as a sampled digital signal) or a digital signal, and may be expressed as A(t)*e^{je(t)}, wherein A(t) can be a positive time varying amplitude, θ(t) can be a time varying phase, and t is time. The signal decomposer component 320 can decompose the input signal Vᵢₙ (analog or digital) into K numbers of decomposed signals (e.g., sinusoidal signals) by using one or more different decomposing algorithms. The decomposition algorithm can be functions of parameters, such as a modulation type, an input signal amplitude, a phase value, a modulation scheme, a carrier frequency, a data rate, a symbol rate, and/or other system specification requirements.

The decomposed signals can then be used to generate modulated output signals to be summed by the summer 350. One or more decomposition algorithms can be employed for decomposing the input signal. For example, the phase of a decomposed signal can be sent to a up-converting modulator for a PLL to up-convert the decomposed signal, and the phase modulated decomposed signal can then be amplified by a VGA using the amplitude of the decomposed signal.

The signal decomposer component 320 can also include output terminals 371-37K coupled to VGAs 331-33K and output terminals 381-38K coupled to modulators 351-35K of the PLLs 391-39K. For example, the first control 371 of the signal decomposer component 320 can be coupled to the first VGA 331, and the K-th control 37K can be coupled to VGA 33K.

In operation, the output signals of the VGAs 331-33K can be added with a summer 350 to form the analog transmitter output 340. In one example, the output 340 can be expressed as A(t)*cos(ωt+θ(t)) for the an input A(t)*e^{jθ(t)}, where ω is a carrier frequency. In general, there can be a VGA for each PLL in the transmitter 300. In some implementations, a single VGA can be placed after the summer 350 instead of before the summer 350, for example, when there is only one carrier. The input signal Vᵢₙ(t) during operation can be decomposed into, for example, K types of signals, in which each decomposed signal can be represented by, for example, A(t)ᵢ*e^{jθi(t)} for i=1, . . . K. A phase θi(t) of an i-th decomposed signal can be sent to a modulator 35i by a control output 37i from the signal decomposer component 320 to modulate a fractional N divider of the PLL feedback loop within PLL 39i and, therefore, modulate the phase of a carrier signal generated by the PLL 39i. Further, the signal decomposer component 320 can send amplitude information, (e.g., Aᵢ(t) of the i decomposed signal) to a VGA 33i to amplitude modulate the i-th phase modulated or up-converted signal, (e.g., cos(ωt+θi(t))) to a modulated signal 34i (e.g., Aᵢ(t)*cos(ωt+θi(t))) with a carrier frequency of ω. When the different modulated signals at the outputs 341-34K of the VGAs 331-33K are combined together, a phase, a frequency, and/or an amplitude modulated up-converted output signal is generated.

Generally, it can be possible to generate arbitrary phase, amplitude and/or frequency modulations using the sum of the phase and amplitude modulated sinusoidal waveforms. In some cases, two PLLs can be sufficient to generate the needed modulation waveform. The system can also be used to generate both single carrier and multi-carrier modulations; and thus, can be useful for both mobile handsets, as well as base station applications. In particular, the system can be used in a multi-carrier environment for a device to be used between different carriers. One aspect of the signal decomposition and use of multiple PLL to up-convert signals for transmission is the reduction of having to change the PLL phase and frequencies rapidly, which can be difficult to achieve without generating signal distortion and noises for high frequency systems, such as for wireless or wireline communication applications.

Example multi-standard transmitters (e.g., a transmitter that is compatible with different wireless standards, such as the Global System for Mobile Communications (GSM standard) or the Wideband Code Division Multiplexing (WCDMA) standard) can provide various performance enhancements. For example, the multi-standard transmitter designs shown herein can offer low noise and high linearity, along with phase and amplitude modulation. The example transmitter designs may be capable of utilizing various digital algorithms. For example, the designs may be implemented in chips, which have increasing levels of digital circuits integrated and implemented on them. The techniques described herein can be used across multiple standards (or outside of established standards), and can produce high performance with low noise. In some implementations, the transmitter 300 can replace the transmitter 100 shown in FIG. 1. In some implementations, the transmitter 300 can sum K VGA outputs at the VGA output terminals 341-34K, in which the amplified output signals from the PLLs 391-39K are derived from phase or amplitude modulation of the input signal Vᵢₙ. In some implementations, the summer can sum a weighted sum of the K VGA outputs, where each of the K VGA outputs may be assigned a numerical weight and may be weighted with respect to each other. The output signal from the transmitter may be a weighted sum of the K VGA outputs. The weights may be the same or they may be different from each other. The weights may also be parameterized.

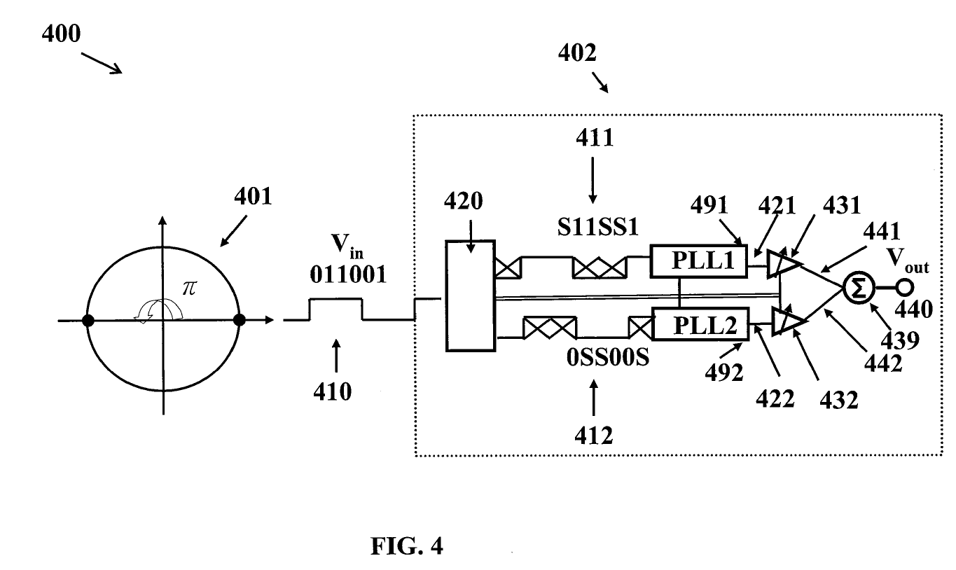

FIG. 4 is a diagram of an example of a technique 400 to decompose an input signal for transmission by a transmitter. The example technique 400 to decompose an input signal Vᵢₙ for transmission by a transmitter 402 can be depicted using techniques similar to those described with respect to FIG. 3. The transmitter 402 can have a decomposer component 420 that sends phases of decomposed signals 411, 412 to PLLs 491, 492, and the PLL outputs 421, 422 can be coupled to VGAs 431, 432. The decomposer can send amplitudes of the decomposed signals 411, 412 to the VGAs 431 and 432. The VGA outputs 441, 442 can be coupled to a summer 439 that has the transmitter output terminal 440.

In one example, a digital input signal Vᵢₙ can be composed into K number of decomposed signals S₁-Sₖ, where K in this example can represent the number of symbols in a modulation scheme. Each decomposed signal of S₁-Sₖ can modulate a higher frequency signal, such as, a carrier signal produced by the PLLs, PLL1-PLLK.

The technique 400 can employ a decomposition algorithm using information from a type of modulation scheme. For example, phase-shift-keying modulation (PSK) is a digital modulation scheme that can convey the input digital signal by modulating a phase of the carrier signal. The PSK modulation may be used in communication systems (e.g., wireless local area network (WLAN), or Wideband Code Division Multiple Access (WCDMA)). One such PSK modulation can be a binary phase-shift-keying (BPSK) of two symbols in phase [1] and out of phase π [0]. As shown in a constellation diagram 401, two points are separated by π (e.g., 180°). A BPSK modulated input signal Vᵢₙ=A(t)*e^{jθ(t)} with θ(t)=0 or π can be represented by one binary bit with two states.

The technique 400 illustrates an example of one decomposition algorithm for a BPSK input signal. For instance, the decomposition number K can use a symbol number of 2 for BPSK. Therefore, two PLLs 491 and 492 can be employed, in which PLL 491 up-converts a signal without a phase shift and PLL 492 up-converts a signal with a phase shift of π.

For an example, the input signal Vᵢₙ(t) can be represented by the input digital code [011001] 410 (e.g., amplitude A(t)*[011001] and phase [011001]) during an operation, in which 1 and 0 can denote the two states θ(t)=0 or θ(t)=π, respectively, and [ ] can denote a vector of states (e.g., [1] is for a signal of phase 0 and [0] is for a signal of phase π).

In an example, a decomposition algorithm can decompose the input digital code [011001] 410 into two decomposed signals 411 and 412. The first decomposed signal 411 can be Vᵢₙ₁=[S11SS1] and the second decomposed signal 412 can be Vᵢₙ₁=[0SS00S], where S can represent a state that forces the amplitude to zero. The signal decomposer component 420 can control the PPLs 491 and 492 to an extent to up-convert the two decomposed signals 411, 412 to cos(ωt) and cos(ωt+π). The VGAs 431 and 432 can amplify the amplitudes (e.g., A(t)*[S11SS1], A(t)*[0SS00S]) of the decomposed signals 411, 412, respectively. The phase and amplitude modulated or up-converted output signals of VGA1 431 and VGA2 432 can be represented by A(t)*[S11SS1]*cos(ωt) and A(t)*[0SS00S]*cos(ωt+π), respectively. As described above, the amplitude and phase modulated decomposed output signals A(t)*[S11SS1]*cos(ωt) and A(t)*[0SS00S]*cos(ωt+π) can then be summed by a summer 439 to generate an output (e.g., Vₒᵤₜ(t)=A(t)*[011001]*cos(ωt+[011001])) at the output terminal 440 of the summer. In some cases, this output may be the same output of one PLL by phase shifting according to the input signal phase. The output signal Vₒᵤₜ(t) can then proceed to a power amplifier (not shown) for transmission.

In some implementations, instead of having to change large phases of one PLL, a transmitter employing two PLLs with a fixed phase may provide enhancements to system performance, particularly for high speed communication systems. Furthermore, the techniques described can be used for an output signal that may be required to include different carrier frequencies in cases where an input signal is used for different wireless carriers by using additional PLLs. For this case of different carriers, an output signal Vₒᵤₜ(t) can include signals of different carrier frequencies generated by different PLLs.

In some implementations, for a band-limited transmitter system, smoothing functions (e.g., pulse shaping) can be applied to the amplitude and phase of Vᵢₙ(t) in between symbol points in order to shape the bandwidth of the transmitted spectrum. In this pulse shaping case, more input samples, acting like an analog input signal, can be used within a time period when compared to not using pulse shape filtering.

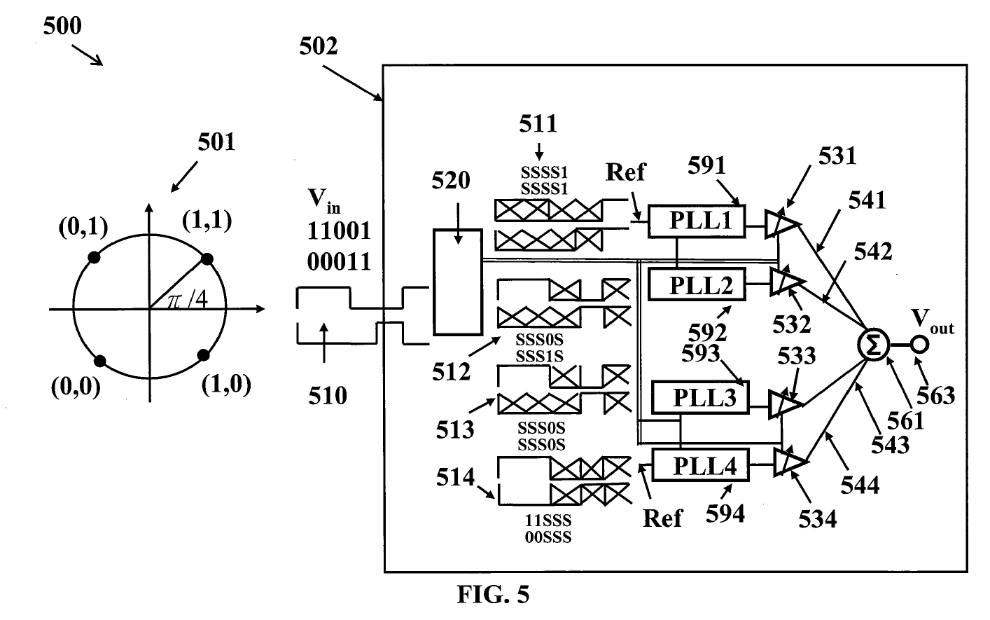

FIG. 5 is a diagram of an example of a transmitting technique 500 involving decomposition of an input signal Vᵢₙ for a quadrature phase-shift-keying (QPSK) modulation scheme. The technique 500 involves a transmitter 502 with a signal decomposer component 520 producing four decomposed signals 511-514 into PLLs 591-594. The PLLs 591-594 are coupled to VGAs 531-534, and the VGAs' output terminals 541-544 are coupled to a summer 561 to produce an output signal at an output terminal 563 of the transmitter 502 and summer 561.

In FIG. 5, a QPSK modulated signal can be represented by a constellation diagram 501. As shown in the QPSK constellation diagram 501, the number of symbols can be 4 symbols and the number of bits used for each symbol can be 2 bits. The input signal Vᵢₙ can include two bits (instead of one bit as in BPSK), and the input signal Vᵢₙ can be decomposed into four decomposed signals for the four constellation points at the four quadrants (e.g., [1,1]=phase shift by π/4, [0,1]=phase shift by 3π/4, [0,0]=phase shift by 5π/4, and [1,0]=phase shift 7π/4, which corresponds to symbol points (1,1), (0,1), (0,0) and (1,0)), as shown in the QPSK constellation diagram 501. For example, a QPSK input signal Vᵢₙ can be represented as input digital code [11001, 00011] 510, in which the amplitude of Vᵢₙ is A(t)*[11001, 00011] and the phase of Vᵢₙ is [11001, 00011].

Using a similar decomposition process to that described with respect to FIGS. 3-4, the output signal Vₒᵤₜ at the output terminal 563 of the summer 561 can be generated. For example, four decomposed signals 511-514 from the input signal Vᵢₙ [11001, 00011] can be represented by Vᵢₙ₁(t)=[SSSS1, SSSS1], Vᵢₙ₂(t)=[SSS0S, SSS1S], Vᵢₙ₃(t)=[SS0SS, SS0SS] and Vᵢₙ₄(t)=[11SSS, 00SSS]. Similarly, the output signals at the output terminals 541-544 of the VGAs 531-534 can be represented by Vₒᵤₜ₁(t)=[SSSS1, SSSS1]*cos(ωt+π/4), Vₒᵤₜ₂(t)=[SSS0S, SSS1S]*cos(ωt+3π/4), Vₒᵤₜ₃(t)=[SS0SS, SS0SS]*cos(ωt+5π/4), and V_{out 4}(t)=[11SSS, 00SSS]*cos(ωt+7π/4). After the modulation process is completed, the decomposed signals at the VGA output terminals 541-544 can be summed to generate Vₒᵤₜ (e.g., Vₒᵤₜ=A(t)*[11001, 00011]*cos(ωt+[11001, 00011])) at the output terminal 563 of the summer 561.

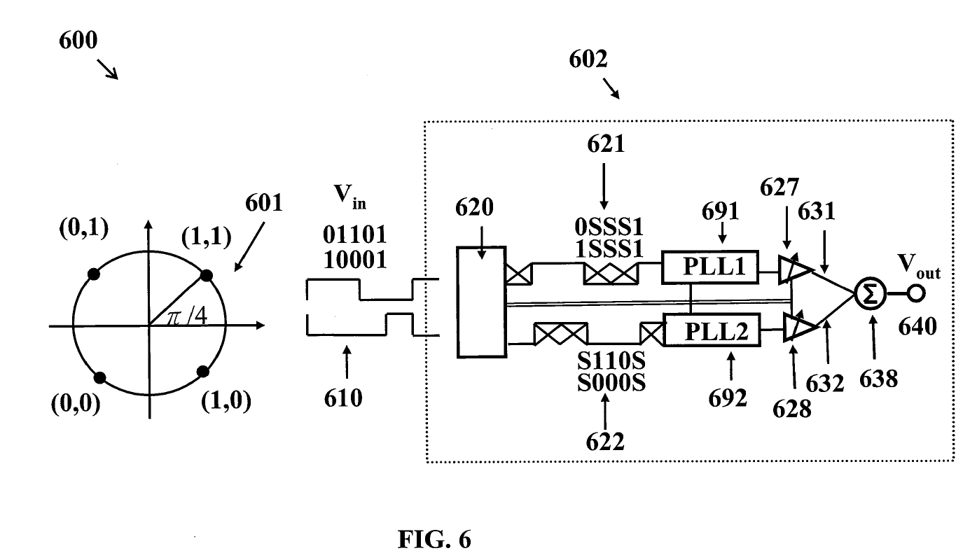

FIG. 6 is an example of a technique 600 for a transmitter 602 to use an alternative decomposition algorithm. The technique 600 may be similar to the technique 500 of FIG. 5. The transmitter 602 can have a signal decomposer component 620 sending decomposed signals 621, 622 to two PLLs 691, 692. The PLLs 691, 692 can couple to VGAs 627, 628, and the output terminals 631, 632 of the VGAs can be coupled to a summer 638. The output terminal 640 of the summer 638 can also be the output terminal of the transmitter 602.

In FIG. 6, the QPSK modulated signal can be represented by a constellation diagram 601, which is the same as constellation diagram 501 in FIG. 5. This example can be used to illustrate the decomposition of the input signal Vᵢₙ with an input digital code [01101, 10001] 610 into two signal groups, where each signal group includes two symbol points in the four quadrants, as described above. In this example, the input signal Vᵢₙ can have an input digital code [01101,10001] that can be decomposed into two signals: decomposed signal 621, Vᵢₙ₁(t)=[0SSS1,1SSS1] for the two phases (1,1) (e.g., π/4 and (0,1); π/4 in the positive y-plane of the diagram 601); and decomposed signal 622, Vᵢₙ₂(t)=[S110S, S000S] for the other two phases (0,1) (e.g., 5π/4) and (0,0) (e.g., 7π/4) in the negative y-plane of the diagram 601.

The modulated decomposed output signals at the output terminals 631, 632 of the VGAs 627, 628 can be represented by Vₒᵤₜ₁(t)=[S110S, S000S]*cos(ωt+[S110S, S000S]), and Vₒᵤₜ₂(t)=[SSS0S, SSS1S]*cos(ωt+[S110S, S000S]), respectively. Similarly, the summed output signal at the output terminal 640 of the summer 638 can be represented as Vₒᵤₜ=A(t)*[11001, 00011]*cos(ωt+[11001, 00011]).

In some implementations, the signal decomposition of the technique 600 can be altered to use two other adjacent signals from what is described with respect to FIG. 6. For instance, the signal decomposition can involve two signals from the right plane, positive x-plane and two signals from the left plane, negative-x plane. There may be other possible decomposition algorithms that may be suitable for use with a particular type of modulation. The techniques described above can be used for other modulation schemes, such as quadrature amplitude modulation (QAM).

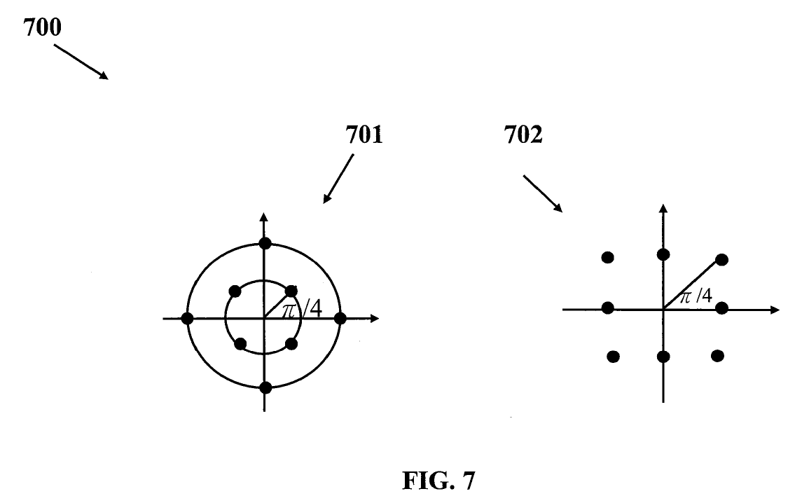

FIG. 7 is an example of constellation diagrams of an 8-Quadrature amplitude modulation (QAM). A constellation diagram 701 for an eight point, 8-QAM modulation can include two circles for different amplitudes. Each circle may be similar to diagram 601 for QPSK modulation of a same amplitude and four quadratic phase shifts. In some implementations, the constellation diagrams for a QAM modulation can be on rectangles, as shown in diagram 702. For 8 QAM, there are 8 symbols and each symbol can be represented by three bits. In these implementations, each input signal Vᵢₙ may have three bits. In some implementations, eight PLLs can be used. In other implementations, two or four PLLs can be used. Similar to the examples shown in FIGS. 5 and 6, an input signal can be decomposed into multiple decomposed signals by using the eight symbol points for the PLLs and VGAs for up-conversions. The techniques described above can be used for other and/or different modulation schemes, such as BPSK, QPSK, QAM, 8QAM, 16QAM, 64QAM, multiple-input and multiple-output (MIMO), and/or multiple channels of modulations.

Various topologies for PLLs can be used including both active and passive implementations of loop filters, charge pump based or voltage mode based integrators, direct VCO modulation instead of indirect modulator through the divider, and all-digital PLL implementations. The PLL can be an analog, a digital or a combined analog and digital PLL. The PLL can be an integer-based PLL, a fractional-based PLL, or a combined integer and fractional-based PLL. The PLL can be of any type, of any order, and can be a single-loop or multi-loop PLL. The PLL can be single-ended, differential, or combined single-ended and differential MOSFETS or bipolar circuits.

In some implementations, the crystal oscillator in the PLL can be replaced by a dielectric resonator or an acoustic wave resonator. The system can also include summers, mixers, filters, analog-to-digital converters (ADCs), digital-to-analog converters (DACs), and analog and digital control circuits. Some of the programmable frequency dividers can be counters, prescalers or dividers with input amplifiers. In some implementations, the disclosed PLL can be combined with one or more techniques for increasing the loop filter bandwidth initially, and then the bandwidth can be switched back to narrower bandwidth after locking, and/or pre-charging the loop filter node, and/or pre-tuning the VCO with one or more disclosed or conventional cycle slipping reduction techniques.

In addition, various modulator types can be used to modulate the phase information onto the VCO, including delta sigma modulation loops of various orders and implementations. In some implementations, the VCO can be replaced by a current controlled-oscillator, a ring oscillator, a relaxation oscillator, a Colpitts oscillator, a Hartley oscillator, a two-integrator oscillator, an LC oscillator, or an RC oscillator. The decomposition of the input into multiple sinusoids can also be done in a variety of manners, including DSP based, direct hardware implementation, and also microprocessor based. In some implementations, different timing controls can be used, differing values can be loaded into the reference and feedback dividers, and even multiple values can be loaded into the dividers during the transient startup process. The exemplary designs may use various process technologies, such as, for example, CMOS or BiCMOS (Bipolar-CMOS) process technology, or Silicon Germanium (SiGe) technology. The circuits can be single-ended or fully-differential circuits.

The disclosed techniques can be used with various and/or multiple wireless and wireline communication systems. For example, the disclosed techniques can be used with transmitters, and transceivers for one or more wireless standards, such as wireless standards for 2G, 3G, and/or 4G wireless communications. In some implementations, the techniques described in this disclosure can be used with radio architectures that support multiple communication standards, such as GSM/EDGE/WEDGE, and emerging standards, such as WiMAX, LTE, and UMB. The techniques in this disclosure can also be used with multi-band radios, GPS, RX Diversity, WLAN, and FM/DTV receivers. In particular, the transmitter 300 may be a multi-standard transmitter. The disclosed techniques can also be used outside of or in addition to these wireless standards.

Certain features that are described in this specification in the context of separate implementations can also be implemented in combination in a single implementation. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The system can include other components. Some of the components may include computers, processors, clocks, radios, signal generators, counters, test and measurement equipment, function generators, oscilloscopes, frequency synthesizers, medical devices, phones, wireless communication devices, and components for the production and transmission of audio, video, and other data.

The number and order of the circuit blocks shown can vary. In addition, the phase and amplitude modulation, and the number of controllable steps, as well as the steps sizes of each of the stages of gain, can also vary. A number of implementations have been described. Nevertheless, it will be understood that various modifications may be made. Accordingly, various modifications and implementations are within the scope of the following claims.

What is claimed is:

1. A transmitter comprising:
a signal decomposer component configured to decompose an input signal into a plurality of decomposed signals, wherein each of the plurality of decomposed signals comprises phase and amplitude information;
a plurality of phase-lock-loops (PLL) configured to:
receive the plurality of decomposed signals, and
generate a plurality of phase-modulated signals by performing modulation based on the phase information from the plurality of decomposed signals;
a plurality of variable amplifiers (VGAs) configured to amplify the plurality of phase-modulated signals with the amplitude information from the plurality of decomposed signals and to generate a plurality of amplitude and phase modulated signals; and
a summer configured to sum the plurality of amplitude and phase modulated signals to generate a modulated output signal.

2. The transmitter of claim 1, wherein each of the plurality of PLLs are configured to receive a reference signal.

3. The transmitter of claim 2, wherein a first input terminal of each of the plurality of VGAs is coupled to an output terminal of one of the PLLs.

4. The transmitter of claim 3, wherein a number of the PLLs is equal to a number of the VGAs, and wherein a number of PLLs is equal to a number of decomposed signals.

5. The transmitter of claim 4, wherein the signal decomposer component is configured to receive the input signal at an input terminal of the signal decomposer component.

6. The transmitter of claim 5, wherein the signal decomposer component comprises a plurality of output terminals, wherein a first input terminal of each of the PLLs is coupled to one of the plurality of output terminals of the signal decomposer component, and a second input terminal of each of the VGAs is coupled to one of the plurality of output terminals of the signal decomposer component.

7. The transmitter of claim 6, wherein each of the PLLs comprises a voltage controlled oscillator (VCO) that couples to the first input terminal of one of the VGAs.

8. The transmitter of claim 7, wherein each of the PLLs comprises a modulator component that couples to the first input terminal of each of the PLLs, wherein the reference signal is received at a second input terminal of each of the PLLs.

9. The transmitter of claim 8, wherein the signal decomposer component is configured to interact with each of the plurality of PLLs and the plurality of VGAs to conduct phase and amplitude modulation for the amplitude and phase modulated signals.

10. The transmitter of claim 9, wherein the amplitude and phase modulated signals comprise frequencies that are higher than frequencies for the plurality of decomposed signals.

11. The transmitter of claim 10, wherein any of the terminals are configured for differential signals.

12. The transmitter of claim 10, wherein any of the terminals are configured for single-ended signals.

13. The transmitter of claim 2, wherein the amplitude and phase modulated signals comprise a plurality of carrier frequencies or a single carrier frequency.

14. The transmitter of claim 1, wherein the plurality of decomposed signals comprises a set of K decomposed signals, wherein K is a number equal to two or greater than two, wherein the plurality of PLLs comprises a set of K PLLs, wherein the plurality of VGAs comprises a set of K VGAs.

15. The transmitter of claim 14, wherein the transmitter is configured to perform a modulation scheme comprising any combination of an amplitude modulation scheme, a frequency modulation scheme, or a phase modulation scheme.

16. The transmitter of claim 15, wherein K is an integer, and wherein K is equal to or less than a symbol number of one of the modulation schemes.

17. The transmitter of claim 16, wherein the input signal is a digital input signal, wherein the symbol number equals to M=2^{N}, and wherein N is a number of bits for the digital input signal.

18. The transmitter of claim 17, wherein a number of the PLLs in the transmitter or a number of the VGAs in the transmitter is a function of 2π/J, where J is a positive integer that is less than the symbol number.

19. The transmitter of claim 15, wherein the modulation scheme comprises any of a phase shift keying (PSK) scheme, a quadrature amplitude modulation (QAM) scheme, a frequency shift keying (FSK) scheme, an amplitude shift keying (ASK) scheme, or an orthogonal frequency division multiplexing (OFDM) scheme.

20. The transmitter of claim 19, wherein the transmitter is configured for more than one of the modulation schemes.

21. The transmitter of claim 1, wherein the transmitter is configured for a system comprising any of a Global System for Mobile Communications (GSM), a Wideband Code Division Multiple Access (WCDMA) system, or a High-Speed Uplink Packet Access (HSUPA) system.

22. The transmitter of claim 1, wherein the input signal is an analog signal.

23. The transmitter of claim 22, wherein the input analog signal is a product of pulse shaping a digital input signal.

24. The transmitter of claim 1 wherein the summer is further configured to sum the plurality of phase-modulated signals to produce a summed phase-modulated signal and the plurality of VGAs comprises one VGA configured to amplify the summed phase-modulated signal with the amplitude information derived from the input signal to produce another modulated output signal.

25. The transmitter of claim 1, wherein any of the PLLs comprises at least any one of a current controlled-oscillator, a ring oscillator, a relaxation oscillator, a Colpitts oscillator, a Hartley oscillator, a two-integrator oscillator, an LC oscillator, or an RC oscillator.

26. The transmitter of claim 1, wherein any of the PLLs comprises any one of a first type of PLL having active and passive loop filters, a second type of PLL having charge pump-based or voltage mode-based integrators, a third type of PLL having a type of direct voltage controlled oscillator (VCO) modulation, a fourth type of PLL comprising an analog PLL, a fifth type of PLL comprising a digital PLL, a sixth type of PLL comprising a combined analog and digital PLL, a seventh type of PLL comprising an integer-based PLL, a fractional-based PLL, or a combined integer and fractional-based PLL, an eight type of PLL comprising a single-loop or multi-loop PLL, a ninth type of PLL comprising an oscillator, a crystal oscillator, a dielectric resonator, or an acoustic wave resonator, or a tenth type of PLL comprising any combination of the types of PLL.

27. A method for a transmitter, the method comprising:
producing two or more phase-modulated signals from two or more voltage controlled oscillators (VCOs), wherein each of the VCOs produces one of the phase-modulated signals;
producing two or more phase and amplitude modulated signals by amplifying the two or more phase-modulated signals with two or more variable gain amplifiers (VGAs), wherein each VGA amplifies one of the phase-modulated signals; and
summing the two or more phase and amplitude modulated signals with a summer circuit to produce an output signal,
wherein,
the transmitter comprises the summer circuit, the two or more VGAs, and two or more phase-locked loops (PLLs), and
wherein each of the PLLs comprises at least one of the VCOs.

28. The method of claim 27 wherein the summer circuit is configured to sum the two or more phase-modulated signals to produce a summed phase-modulated signal and the two or more VGAs comprises one VGA configured to amplify the summed phase-modulated signal with an amplitude information associated with the input signal to produce another output signal.

29. The method of claim 27, further comprising performing amplitude modulation with the VGAs.

30. The method of claim 29, wherein the transmitter comprises a signal decomposer component.

31. The method of claim 30, wherein each of the PLLs are configured to receive a reference signal and one of the decomposed signals, and wherein each of the PLLs are configured to generate one of the phase-modulated signals by performing modulation with the phase information from the one decomposed signals.

32. The method of claim 31, wherein each of the VGAs are configured to amplify one of the phase-modulated signals with the amplitude information from one of the decomposed signals and generate one of the amplitude and phase modulated signals.

33. The method of claim 30, further comprising:
receiving an input signal at the signal decomposer component;
decomposing the input signal with the signal decomposer component to generate decomposed phase and amplitude information from the input signal;
receiving a reference signal in each of the two or more PLLs;
sending the decomposed phase information from the signal decomposer component to each of the two or more PLLs to perform phase modulation using the reference signal of each of the two or more PLLs; and
sending the decomposed amplitude information from the decomposed input signal to each of the two or more VGAs to perform amplitude modulation when amplifying the two or more phase-modulated signals with the two or more VGAs.

34. The method of claim 33, further comprising using the signal decomposer component to control the performing of the phase modulation and the amplitude modulation.

35. The method of claim 34, wherein the phase modulation comprises performing a frequency up-conversion process using at least one carrier frequency.

36. The method of claim 35, wherein the two or more phase-modulated signals comprise at least two different carrier frequencies.

37. The method of claim 36, wherein any of the carrier frequencies are higher than frequencies from signals generated from the signal decomposer component.

38. The method of claim 33, further comprising modulating the input signal using a modulation scheme comprising any of a phase shift keying (PSK) scheme, a quadrature amplitude modulation (QAM) scheme, a frequency shift keying (FSK) scheme, an amplitude shift keying (ASK) scheme, an orthogonal frequency division multiplexing (OFDM) scheme, a multiple-input and multiple-output (MIMO) scheme, a Gaussian minimum-shift keying (GMSK) scheme, or a multiple-channel modulation scheme.

39. The method of claim 33, further comprising using one or more decomposing algorithms for decomposing the input signal with the signal decomposer component.

40. The method of claim 33, wherein the input signal is a digital signal.

41. The method of claim 33, wherein the input signal comprises N number of bits to represent a state of the input signal, wherein the input signal is associated with a symbol number M, and wherein the symbol number M is a function of 2^{N}.

42. The method of claim 41, wherein a number of the PLLs in the transmitter or a number of the VGAs in the transmitter is equal to or less than the symbol number.

43. The method of claim 42, wherein a number of the PLLs in the transmitter or a number of the VGAs in the transmitter is a function of 2π/J, where J is a positive integer that is less than the symbol number.

44. The method of claim 33, wherein the input signal comprises an analog signal.

45. The method of claim 44, further comprising generating the analog signal by pulse shaping a digital input signal.

46. The method of claim 45, wherein the analog signal comprises a digitally-sampled analog signal.

47. The method of claim 33, wherein the input signal is received from a baseband signal component.

48. The method of claim 33, wherein each of the VGAs is coupled with at least one of the PLLs, and wherein each VGA is coupled to a different PLL.

49. The method of claim 33, further comprising representing the output signal in a type of constellation diagram, wherein the type of constellation diagram corresponds with a type of modulation scheme performed with the production of the output signal.

50. The method of claim 49, wherein the type of modulation scheme comprises a digital modulation or a continuous minimum shift modulation.

51. The method of claim 27, further comprising using the transmitter in a system for a Global System for Mobile Communications (GSM), a Wideband Code Division Multiple Access (WCDMA) system, or a High-Speed Uplink Packet Access (HSUPA) system.

52. The method of claim 27, further comprising using the transmitter in a system for Worldwide Interoperability for Microwave Access (WiMAX), multi-band radios, global-positioning systems (GPS), RX Diversity, wireless local area network (WiLAN), or frequency modulation (FM) or satellite receivers.

53. A method for transmitter operation, the method comprising:
decomposing an input signal into a plurality of decomposed signals using a signal decomposer component, wherein each of the plurality of decomposed signals comprises phase and amplitude information;
receiving the plurality of decomposed signals with a plurality of phase lock loops (PLLs);
generating a plurality of phase-modulated signals with the plurality of PLLs by performing modulation based on the phase information from the plurality of decomposed signals;
amplifying the plurality of phase-modulated signals with a plurality of variable amplifiers (VGAs) using the amplitude information from the plurality of decomposed signals;
generating a plurality of amplitude and phase modulated signals from the plurality of VGAs; and
summing the plurality of amplitude and phase modulated signals with a summer to generate a modulated output signal,
wherein:
the signal decomposer component is coupled to each of the PLLs and each of the VGAs,
each of the VGAs is coupled to one of the plurality of PLLs, and
each of the VGAs is coupled to the summer.

54. The method of claim 53, further comprising using the signal decomposer component to interact with each of the plurality of PLLs and the plurality of VGAs to conduct phase and amplitude modulation for each of the amplitude and phase modulated signals.

55. The method of claim 54, further comprising modulating the input signal using a modulation scheme comprising any of a phase shift keying (PSK) scheme, a quadrature amplitude modulation (QAM) scheme, a frequency shift keying (FSK) scheme, an amplitude shift keying (ASK) scheme, an orthogonal frequency division multiplexing (OFDM) scheme, a multiple-input and multiple-output (MIMO) scheme, a Gaussian minimum-shift keying (GMSK) scheme, or a multiple-channel modulation scheme.

56. The method of claim 53, further comprising summing the plurality of phase-modulated signals using the summer to produce a summed phase-modulated signal and the plurality of VGAs comprises one VGA configured to amplify the summed phase-modulated signal with an amplitude information of the input signal to generate another modulated output signal.

57. The method of claim 53, further comprising receiving a reference signal into the plurality of PLLs.

58. The method of claim 57, wherein the reference signal is received from a voltage reference source.

59. The method of claim 53, further comprising sending the modulated output signal to a power amplifier for transmission.

60. The method of claim 53, wherein each of the PLLs are configured to receive a reference signal and one of the decomposed signals, and generate one of the phase-modulated signals by performing modulation with the phase information from the one decomposed signals.

61. The method of claim 60, wherein each of the VGAs are configured to amplify one of the phase-modulated signals with the amplitude information from one of the decomposed signals, and wherein each of the VGAs are configured to generate one of the amplitude and phase modulated signals.

62. The method of claim 53, wherein the plurality of decomposed signals comprises a set of K decomposed signals, wherein K is a number equal to two or greater than two, wherein the plurality of PLLs comprises a set of K PLLs, wherein the plurality of VGAs comprises a set of K VGAs.

63. The method of claim 62, wherein the transmitter is configured to perform a modulation scheme comprising any combination of an amplitude modulation scheme, a frequency modulation scheme, or a phase modulation scheme.

64. The method of claim 63, wherein K is an integer, and wherein K is equal to or less than a symbol number of one of the modulation schemes.

65. The method of claim 64, wherein the input signal is a digital input signal, wherein the symbol number equals to M=2^{N}, and wherein N is a number of bits for the digital input signal.

66. The method of claim 65, wherein a number of the PLLs in the transmitter or a number of the VGAs in the transmitter is a function of 2π/J, where J is a positive integer that is less than the symbol number.

67. The method of claim 53, wherein the modulated output signal comprises one or more carrier frequencies.

68. The method of claim 53, wherein the input signal comprises an analog input signal, the method further comprising generating the analog signal by pulse shaping a digital input signal.

69. The method of claim 68, wherein the analog signal comprises a digitally-sampled analog signal.

70. The method of claim 70, wherein the input signal is received from a baseband signal component.

71. The method of claim 53, further comprising assigning a numerical weight to each of the plurality of amplitude and phase modulated signals from the plurality of VGAs before summing the plurality of amplitude and phase modulated signals, wherein the modulated output signal comprises a weighted sum of the plurality of amplitude and phase modulated signals.

72. The method of claim 53, further comprising performing signal processing with the signal decomposer component.
